(19) United States
(12) Patent Application Publication
(10) Pub. No.: US 2004/0092188 A1
(43) Pub. Date: May 13, 2004

(54) Clothing material structure of fiber cloth containing PAN series activated carbon

(76) Inventor: Shih-Ju Hsieh, Taichung (TW)

Correspondence Address: CHARLES E. BAXLEY, ESQUIRE, Hart, Baxley, Daniels & Holton, 59 John St, 5 FL, New York, NY, 10038, US

(21) Appl. No.: 10/289,561

(22) Filed: Nov. 8, 2002

(51) Int. Cl. D03D 15/00; D03D 25/00; B32B 5/26; B32B 7/12; B32B 18/00

(52) U.S. Cl. 442/239; 442/240; 442/243; 442/244; 442/265; 442/301

(57) ABSTRACT

A clothing material structure of fiber cloth containing PAN series activated carbon includes an air-permeable textile as a support layer and fiber cloth containing PAN series activated carbon as an adsorption layer. The support layer and the adsorption layer are bonded together to form the clothing material suitable for the hunter clothing and the protective clothing by way of bonding or needle punching. Accordingly, when the wearer's body heat and body odor try to pass through the clothing made from the material, the body heat may smoothly pass through the adsorption layer while the body odor is blocked and filtered out by the activated carbon fiber. Thus, the requirements of hunter clothing may be satisfied. Furthermore, the odors or toxins trying to pass through the adsorption layer may be filtered out, and the requirements of the chemically protective clothing and hunter clothing may be satisfied.

### BACKGROUND OF THE INVENTION

1. Field of the Invention

The invention relates to a clothing material structure of fiber cloth containing PAN series activated carbon, and more particularly to a clothing material, which is suitable for the clothing such as chemically protective clothing, hunter clothing, and the like, and contains fiber cloth of PAN series activated carbon as an adsorption layer and an air-permeable textile as a support layer.

2. Description of the Related Art

Conventionally, textiles, such as chemically protective clothing, hunter clothing, and the like, capable of filtering out odors or toxic gases mainly contain activated carbon particles bonded to the textiles. Thus, the textiles may filter out the odors or toxins through the activated carbon particles. For example, UK Patent No. GB-1173142 discloses an example using activated carbon particles in the filtering structure of the clothing. It is to be noted that the activated carbon particles and the textiles are combined by mixing the activated carbon particles with glue and then bonding the particles into the air-permeable textiles. However, the glue may shroud the hollows between the activated carbon particles, thereby deteriorating the adsorptive effects thereof. Furthermore, the activated carbon particles tend to separate from the textiles when the textiles are used. Thus, the toxic gases or organic gases may pass through the textiles and the filtering effects of the textiles may be greatly deteriorated. In addition, U.S. Pat. No. 4,455,187 discloses a textile filtering structure using powdered activated carbon particles as filter material and a polymeric binding agent bonded to the air-permeable textile. However, the textile filtering structure cannot effectively prevent the glue or binding agent from shrouding the activated carbon particles or avoid the separation of the particles from the textile.

In view of the serious defects resulting from the particles of activated carbon in the filtering applications of clothing, the fibered activated carbon has been developed. However, not all of the fibered activated carbon may be adopted as the clothing material. Consequently, the invention tries to provide a clothing material structure containing an activated carbon fiber.

### SUMMARY OF THE INVENTION

A primary object of the invention is to provide a clothing material structure of fiber cloth containing PAN series activated carbon. The clothing material structure includes an air-permeable textile as a support layer and fiber cloth containing PAN series activated carbon as an adsorption layer. The support layer and the adsorption layer are bonded together to form the clothing material suitable for the hunter clothing and the protective clothing by way of bonding or needle punching. Accordingly, the odors or toxins trying to pass through the adsorption layer may be filtered out, and the requirements of the chemically protective clothing and hunter clothing may be satisfied.

Further benefits and advantages of the present invention will become apparent after a careful reading of the detailed description with appropriate reference to the accompanying drawings.

### BRIEF DESCRIPTION OF THE DRAWINGS

FIG. 1 is an exploded and pictorial view showing the material structure according to one embodiment of the invention.

FIG. 2 is a cross-sectional view showing the combination structure of FIG. 1.

FIG. 3 is an exploded and pictorial view showing the material structure according to another embodiment of the invention.

FIG. 4 is a cross-sectional view showing the combination structure of FIG. 3.

FIG. 5 is a schematic illustration showing the material of the invention applied to the clothing.

### DETAILED DESCRIPTION OF THE INVENTION

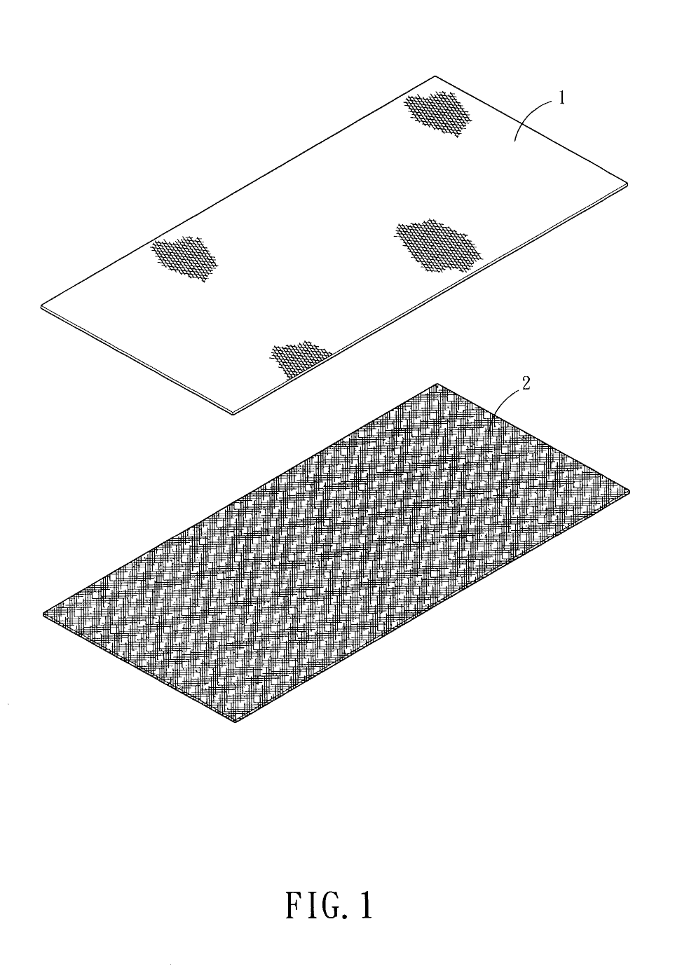

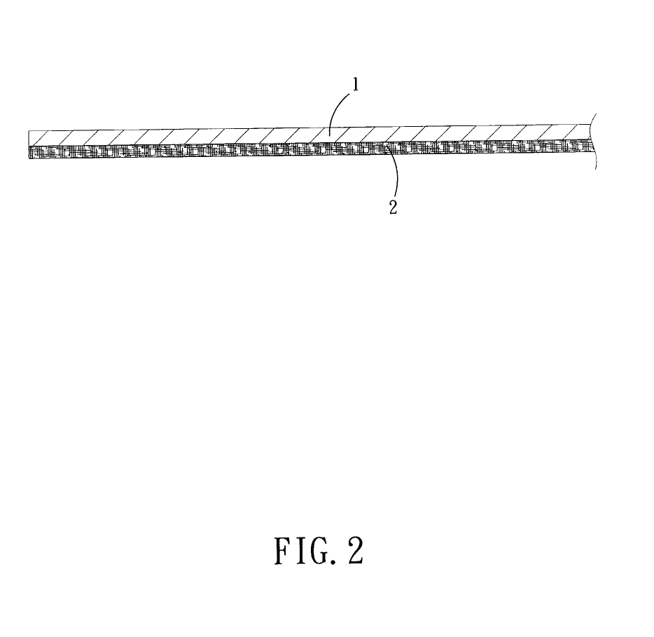

The above-mentioned and other objects, features and advantages of this invention will be easily understood with reference to the embodiments in conjunction with the drawings. Referring first to FIGS. 1 and 2, the clothing material structure of fiber cloth containing PAN series activated carbon of the invention is composed of a support layer 1 and an adsorption layer 2.

The support layer 1 may be composed of an air-permeable textile, such as the T/C woven cloth, through which the body heat or odor of the wearer may pass. In addition, if the cloth is formed as the hunter clothing, the support layer 1 may be the air-permeable cloth or printed cloth having camouflage patterns.

The adsorption layer 2 may be the fiber cloth containing the PAN series activated carbon (the example may have the specifications of a warp density of 38 lines/inch, a weft density of 32 lines/inch, basic weight of 120 g/m² and specific surface area of 300 to 2500 m²/g). The components of the yarn used in the activated carbon fiber cloth may contain the PAN series activated carbon fiber having 5% to 100% activated carbon. The adsorption layer 2 may combine with the support layer 1 by way of needle punching or bonding, wherein the support layer 1 possesses the function of protecting and enhancing the fiber cloth containing the PAN series activated carbon. In addition, the fiber cloth with the PAN series activated carbon may also have the pattern of the knitting cloth.

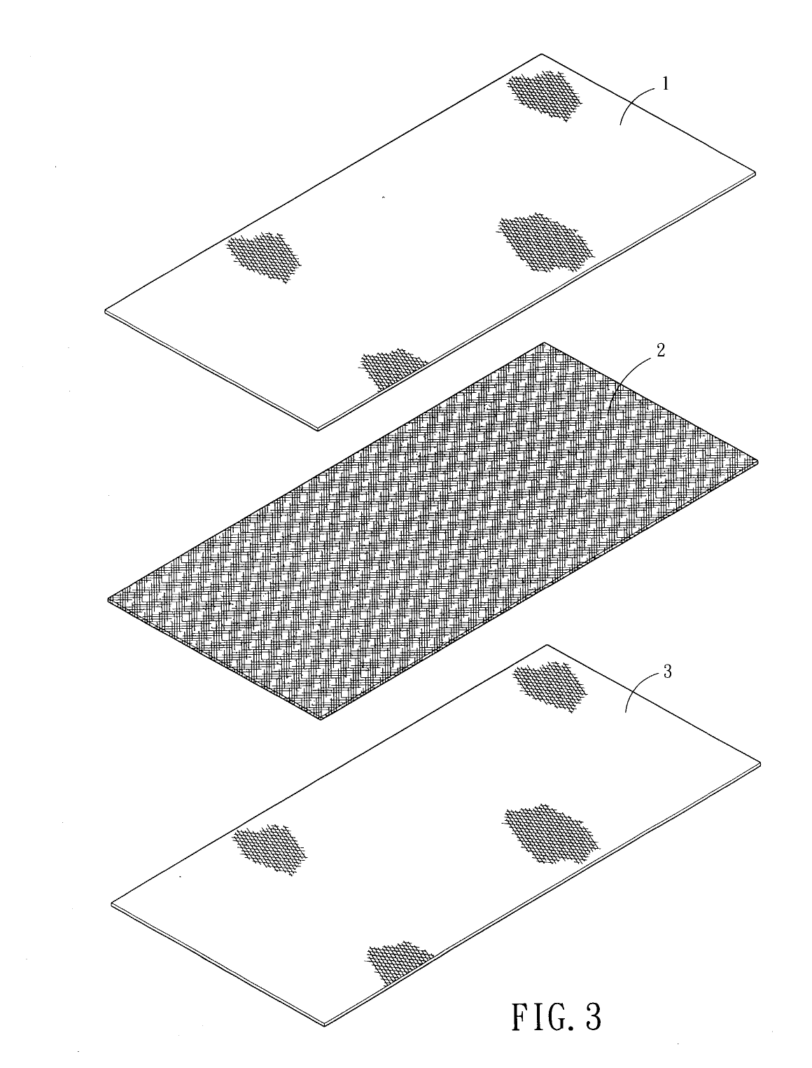

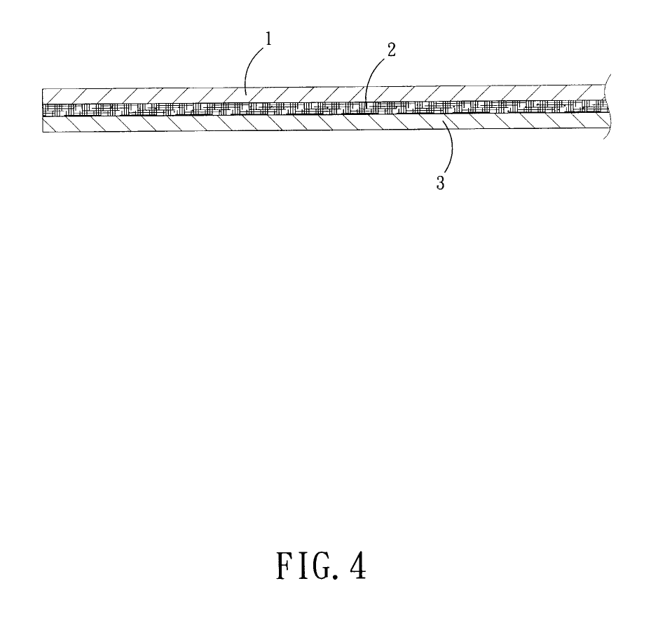

In practical use, the support layer 1 is attached to a side of the adsorption layer 2, and a passivation layer 3, which may be composed of the woven cloth, knitting cloth or polyester non-woven cloth (the basic weight may be 30 nm²), may further be attached to the other side of the adsorption layer 2, as shown in FIG. 3. In addition, the support layer 1, adsorption layer 2 and passivation layer 3 may be integrally combined, by way of needle punching or bonding, to form the clothing material as shown in FIG. 4.

After the clothing is formed from the above-mentioned material structure, when the wearer's body heat or body odor passes through the clothing for dispersion, the body heat or body odor may exit from the passivation layer 3 to the adsorption layer 2 and the support layer 1 in sequence. It is to be noted that the body heat may smoothly pass through the adsorption layer 2 while the body odor may be blocked and filtered out by the fiber cloth containing the activated carbon (the usage requirements of the hunter clothing are satisfied). Furthermore, when the external organic toxins and toxic gases try to enter the wearer's body from the support layer 1, they will be adsorbed and blocked by the adsorption layer 2, and the wearer is free from being hurt (the usage requirements of the protective clothing are satisfied).

It is appreciated that in the clothing material structure of the invention, because the PAN series activated carbon fiber possesses high adsorptive effects, better intensity and uniform distribution and is free from crushing and separating, the clothes made of the clothing material in conjunction with the structure of the invention are comfort, soft and may be repeatedly cleaned using water. Furthermore, after the adsorption layer 2 is saturated, the clothes may be desorbed for reproduction using hot vapor or hot air. On the contrary, the Rayon series activated carbon fiber has the defect of low intensity and is easy to be crushed.

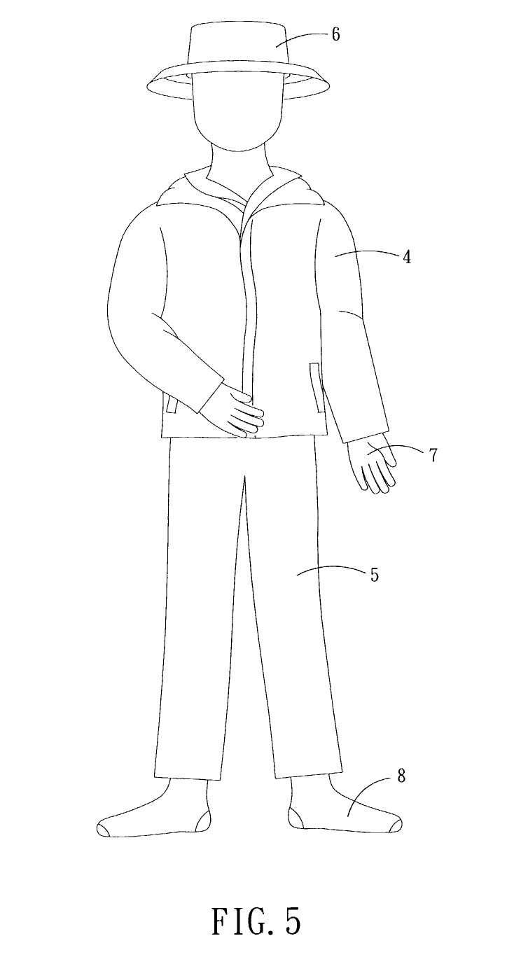

In addition, although the clothing material structure of the invention is in the form of drapery structure, it may be used in various occasions by selecting desired external cloth. As shown in FIG. 5, the clothing material may be sewn into clothes 4, pants 5, caps 6, gloves 7, shoes, hosiery 8 or shoe pads, respirators, carpets, knapsacks, and the like, so as to meet the actual usage requirements.

To sum up, the structure disclosed in the embodiments includes an air-permeable textile as a support layer and fiber cloth containing PAN series activated carbon as an adsorption layer. The support layer and the adsorption layer are bonded together to form the clothing material suitable for the hunter clothing and the protective clothing by way of bonding or needle punching. Accordingly, the odors or toxins trying to pass through the adsorption layer may be filtered out, and the requirements of the chemically protective clothing and hunter clothing may be satisfied.

While the preferred embodiments of the present invention have been shown and described, it will be apparent to those skilled in the art that various modifications may be made in the embodiments without departing from the spirit of the present invention. Such modifications are all within the scope of the present invention.

What is claimed is:

1. A clothing material structure of fiber cloth containing the PAN series activated carbon, comprising:
a support layer composed of an air-permeable textile through which body heat may pass;
a adsorption layer attached to the support layer, the adsorption layer is composed of fiber woven cloth containing PAN series activated carbon, the fiber woven cloth being woven from fiber yarn containing PAN series activated carbon, wherein the support layer protects and enhances the fiber cloth containing the PAN series activated carbon so as to filter out odors and toxic gases.

2. The clothing material structure according to claim 1, further comprising a passivation layer attached to the adsorption layer and opposite to the support layer, the passivation layer being an air-permeable textile.

3. The clothing material structure according to claim 1, wherein the support layer and the adsorption layer are integrally combined by way of bonding.

4. The clothing material structure according to claim 1, wherein the support layer and the adsorption layer are integrally combined by way of needle punching.

5. The clothing material structure according to claim 2, wherein the passivation layer and the adsorption layer are integrally combined by way of bonding.

6. The clothing material structure according to claim 2, wherein the passivation layer and the adsorption layer may be integrally combined by way of needle punching.

7. The clothing material structure according to claim 1, wherein the fiber cloth containing PAN series activated carbon of the adsorption layer may be of a knitting cloth structure.

8. The clothing material structure according to claim 1, wherein the yarn contains a PAN series activated carbon fiber of 5% to 100% activated carbon.
